(19) United States
(12) Patent Application Publication
(10) Pub. No.: US 2016/0029460 A1
(43) Pub. Date: Jan. 28, 2016

(54) MODULAR LIGHTING SYSTEM

(71) Applicant: R.A. Phillips Industries, Inc., Santa Fe Springs, CA (US)

(72) Inventors: Adam Bean, Hacienda Heights, CA (US); Tom D. Flokstra, Hamilton, MI (US)

(21) Appl. No.: 14/809,138

(22) Filed: Jul. 24, 2015

Related U.S. Application Data
(60) Provisional application No. 62/029,339, filed on Jul. 25, 2014.

(51) Int. Cl. H05B 37/02

(52) U.S. Cl. CPC H05B 37/0227; H05B 37/0236; H05B 37/0263

(57) ABSTRACT

A modular lighting system including: a plurality of light modules; a master controller including a first sensor configured to detect a first trigger event, the master controller being configured to control a state of the plurality of light modules based on the detection of the first trigger event; and one or more dedicated controllers including a first dedicated controller, the first dedicated controller including a second sensor configured to detect a second trigger event, the first dedicated controller being configured to control one or more adjacent light modules of the plurality of light modules based on the detection of an associated second trigger event, wherein the plurality of light modules and the one or more dedicated controllers are coupled to the master controller along a serial connection through one or more pass-through electrical connections.

### CROSS-REFERENCE TO RELATED APPLICATION

This application claims the benefit of and priority to U.S. Provisional Application No. 62/029,339, filed Jul. 25, 2014, the entire content of which is incorporated herein by reference.

### BACKGROUND

The present invention relates to the field of lighting systems for vehicles and structures.

### SUMMARY

Aspects of embodiments of the present invention are directed toward a modular lighting system utilizing a number of modular lights that may be individually controlled by dedicated controllers (e.g., dedicated sensors) and/or collectively controlled by a master controller (e.g. a master sensor). The modular lighting system may be used in a truck to illuminate the inside of a trailer or in any building or structure. Any number of modular lights and controllers (e.g., sensors) may be serially connected in any order desired, thus allowing great flexibility in designing a lighting system. The light and sensor modules of the modular lighting system utilize pass-through electrical connections, which greatly simplify the connectivity of the lighting system.

According to embodiments of the present invention, there is provided a modular lighting system including: a plurality of light modules; a master controller including a first sensor configured to detect a first trigger event, the master controller being configured to control a state of the plurality of light modules based on the detection of the first trigger event; and one or more dedicated controllers including a first dedicated controller, the first dedicated controller including a second sensor configured to detect a second trigger event, the first dedicated controller being configured to control one or more adjacent light modules of the plurality of light modules based on the detection of an associated second trigger event, wherein the plurality of light modules and the one or more dedicated controllers are coupled to the master controller along a serial connection through one or more pass-through electrical connections.

In an embodiment, each of the one or more dedicated controllers is configured to control only a corresponding nearest one of the one or more adjacent light modules.

In an embodiment, each of the one or more dedicated controllers is configured to control only the one or more adjacent light modules, and the one or more adjacent light modules include all of light modules of the plurality of light modules following the first dedicated controller along the serial connection, and preceding a termination module or a subsequent dedicated controller of the one or more dedicated controllers.

In an embodiment, the each of the first and second sensors includes at least one of a motion sensor, a proximity sensor, a temperature sensor, and a sound sensor.

In an embodiment, one of the first and second sensors is configured to respond to a trigger event different from an other one of the first and second sensors.

In an embodiment, each of the one or more dedicated controllers is configured to control the one or more adjacent light modules by overriding the master controller.

In an embodiment, the master controller further includes a first switch configured to supply power to, and to cut off power from, all of the one or more dedicated controllers and the plurality of light modules in response to a lack of trigger event for a period of time.

In an embodiment, the master controller further includes a first switch configured to supply power to, and to cut off power from, all of the one or more dedicated controllers and the plurality of light modules in response to a disable signal received from external circuitry.

In an embodiment, the master controller is configured to control a state of each of the plurality of light modules not adjacent to a preceding dedicated controller of the one or more dedicated controllers.

In an embodiment, each of the plurality of light modules is configured to be controlled by the master controller when not adjacent to a preceding dedicated controller of the one or more dedicated controllers.

In an embodiment, each of the plurality of light modules is configured to receive power from the master controller and/or an adjacent one of the one or more dedicated controllers.

In an embodiment, the one or more pass-through electrical connections include a common power supply and a common ground.

In an embodiment, the modular lighting system further includes a terminal module configured to isolate output ports of a last light module of the plurality of light modules from the external environment.

In an embodiment, a number of input ports of the one or more dedicated controllers is the same as a number of the one or more pass-through electrical connections, and a number of output ports of the one or more dedicated controllers is one greater than the number of input ports.

In an embodiment, a number of output ports of the plurality of light modules is the same as a number of the one or more pass-through electrical connections, and a number of input ports of the plurality of light modules is one greater than the number of output ports.

In an embodiment, outputs of the one or more dedicated controllers are configured to mate with and directly engage inputs of the plurality of light modules.

In an embodiment, any of the plurality of light modules and the sensors are interchangeable with one another.

According to embodiments of the present invention, there is provided a modular lighting system including: a plurality of light modules; a master controller including a first sensor configured to detect a first trigger event, the master controller being configured to control a state of the plurality of light modules based on the detection of the first trigger event; and one or more dedicated controllers including a first dedicated controller, the first dedicated controller including a second sensor configured to detect a second trigger event, the first dedicated controller being configured to control one or more adjacent light modules of the plurality of light modules based on the detection of an associated second trigger event, wherein the plurality of light modules and the one or more dedicated controllers are coupled to the master controller in a tree structure including one or more branches, ones of the plurality of light modules and ones of the one or more dedicated controllers coupled along a same branch of the one or more branches being configured to receive electrical power and a control signal from a same one or more pass-through electrical connections.

### BRIEF DESCRIPTION OF THE DRAWINGS

The accompanying drawings, together with the specification, illustrate exemplary embodiments of the present invention, and, together with the description, serve to explain aspects of embodiments of the present invention. In the drawings, like reference numerals are used throughout the figures to reference like features and components. The figures are not necessarily drawn to scale. The above and other features and aspects of the present invention will become more apparent by the following detailed description of illustrative embodiments thereof with reference to the attached drawings, in which:

FIG. 1 is a block diagram of a modular lighting system, according to an illustrative embodiment of the present invention;

FIG. 2A is a schematic diagram of the modular lighting system 100-1 showing the internal circuitry of some of the constituent modules, according to an embodiment of the present invention;

FIG. 2B is a schematic diagram of the modular lighting system 100-2 showing the internal circuitry of some of the constituent modules, according to another embodiment of the present invention;

FIGS. 3A-3C illustrate perspective views of a light module 130-3, according to an embodiment of the present invention; and

FIGS. 3D-3E illustrate perspective views of a light modules 130-4, according to another embodiment of the present invention.

### DETAILED DESCRIPTION

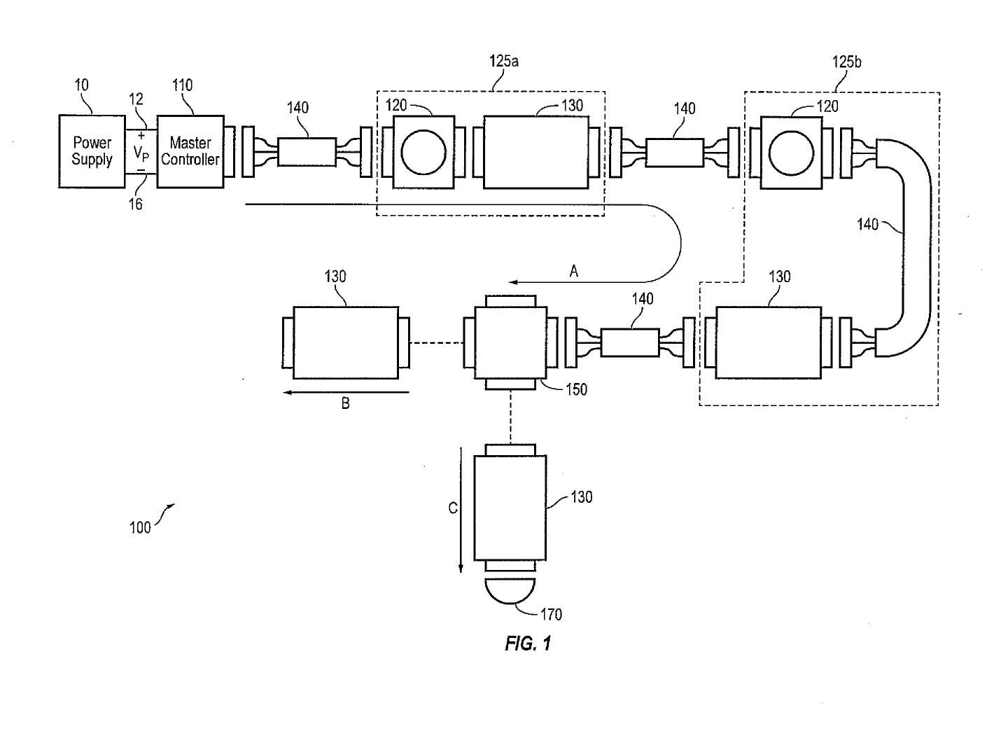

FIG. 1 is a block diagram of a modular lighting system 100, according to an illustrative embodiment of the present invention.

According to an embodiment of the present invention, the modular lighting system 100 is made up of a number of modules including one or more dedicated controllers 120 and one or more light modules 130, which may be serially coupled together (e.g., electrically connected to one another in an in-line or pass-through fashion) via one or more harnesses 140. In an embodiment, the modular lighting system 100 further includes a master controller 110, which may be serially coupled to the one or more dedicated controllers 120 and the one or more light modules 130. A power supply 10 may provide electrical power (with voltage at, e.g., 12 V or 24V) to the modular lighting system 100 through a power line 12 and a ground line 16. In an example of the modular lighting system 100 being used in a truck, the power supply 10 may be a tractor battery or an auxiliary battery in the trailer. The input and output of each dedicated controller 120, light module 130, and harness 140 includes a connector (e.g., a male or female connector) having 3 or more ports/pins for electrically conducting a power signal, a control signal, and a ground signal. This allows the electrical power from the power supply 10 to pass through one module to the next in a serial fashion, thus powering the entire modular lighting system 100.

According to an embodiment, any number of dedicated controllers 120 and light modules 130 may be included in the modular lighting system 100. However, in a real-world implementation, the number of modules may be limited by the ability of the power supply 10 to supply sufficient electrical power to power all of the modules.

In an embodiment, the modules of the modular lighting system 100 are serially connected as a single branch (e.g., branch A). In other embodiments, the master controller 110 may be coupled to (and control) two or more branches of modules. Each branch of modular lighting system 100 may be split into two or more sub-branches (e.g., sub-branches B and C) via a junction module 150 at any point along the branch. The junction module 150 may have one input and two or more outputs carrying identical power, ground, and control signals. Thus, the modular lighting system 100 may have a tree structure with the master controller 110 as a base for the tree. Each branch or sub-branch may be terminated with a module (e.g., a light module 130) with its output unconnected to any other block (as shown at the end of sub-branch B) and left exposed to the external environment, or may be terminated with a terminal module 170 (e.g., a terminal cap, as shown at the end of sub-branch C) that may ensure that the output pins/ports of the last module are electrically isolated from one another and the external environment.

In an embodiment, the master controller 110 controls the state (e.g., the ON/OFF state) of one or more of the modules (e.g., all of the modules) in the modular lighting system 100, while the dedicated controller 120 controls the state (e.g., the ON/OFF/off state) of an adjacent (or paired) light module 130 that is coupled to the output port of the dedicated controller 120. In an embodiment, a dedicated controller 120 controls its adjacent/paired light module 130 via a control signal, which, unlike the power and ground signals, may not propagate through to the next module in the modular lighting system 100. In another embodiment, the dedicated controller 120 may control all of the downstream light modules 130 (i.e., light modules 130 coupled to the output of said dedicated controller 120) that precede a subsequent dedicated controller 120. In such a case, the control signal may propagate downstream and be terminated or modified at the subsequent dedicated controller 120. The dedicated controller 120 and light module 130 pair may be directly coupled to one another (as shown, e.g., in pairing formation 125a) or may be separated by one or more harnesses 140 (as shown, e.g., in pairing formation 125b).

Each of the master and dedicated controllers 110 and 120 may include a sensor for detecting a trigger event that may entail toggling the state of the one or more of the light modules 120. In an embodiment, each of the master and dedicated controllers 110 and 120 may include a motion sensor (e.g., a passive infrared (PIR) sensor), a proximity sensor, a temperature sensor, a sound sensor, and/or the like. Further, each controller 110/120 may include a timer for measuring the passage of time from, for example, a trigger event. The trigger event may, for example, be the sensing of motion within a spatial region within a trailer (as may occur when a user/driver steps into a trailer). In an embodiment, all of the master and dedicated controllers may respond to the same trigger event (e.g., motion detection); while in other embodiments, some or all of the dedicated controllers 120 may respond to a trigger event that is different from that of the master controller 110.

In an embodiment, detecting a trigger event by the master controller 110 may lead to all of the light modules 130 in the modular lighting system to be turned on. Similarly, a lack of a trigger event or a passage of a predetermined period of time from a last trigger event may prompt the master controller 110 to turn off all of the module lights 130. In an embodiment, the master controller 110 additionally disables/activates the one or more dedicated controllers 120 in the modular lighting system 100 based on the occurrence or lack of a trigger event.

In an embodiment, when a dedicated controller 120 detects a trigger event, it is able to override or supplement the master controller 110. For example, even if the master controller 110 has not detected any trigger events and calls for all of the light modules 130 to be turned off, when a particular dedicated controller 120 detects a trigger event, the dedicated controller may be able to turn on its adjacent (or paired) lighting module(s) 130. In another example, when the master controller 120 calls for all light modules 130 to be turned on, a dedicated controller 120 may turn off its adjacent light module(s) after a period of time (e.g., a predetermined amount of time).

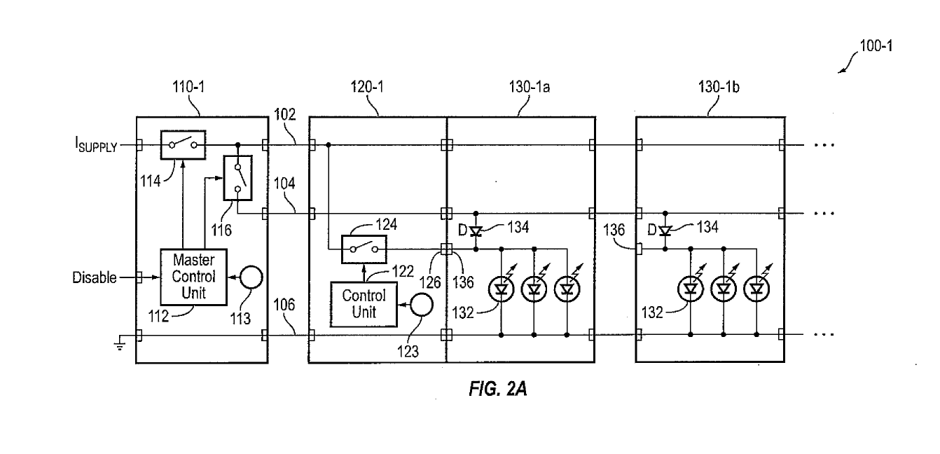

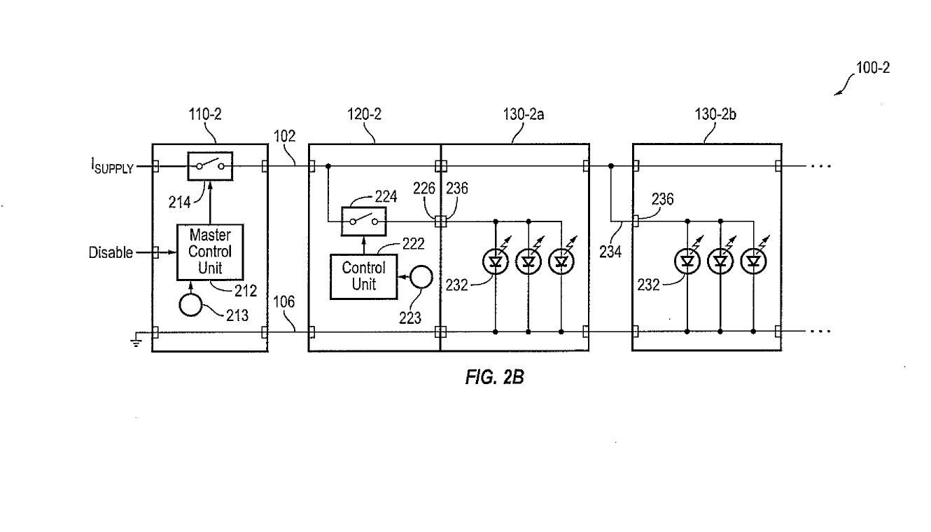

FIG. 2A is a schematic diagram of the modular lighting system 100-1 showing the internal circuitry of some of the constituent modules, according to an embodiment of the present invention. The modular lighting system 100-1 may be substantially similar to the modular lighting system 100 described with reference to FIG. 1, thus, a discussion of features and functionalities that were previously discussed may not be repeated hereinafter.

According to an embodiment, the modular lighting system 100-1 includes three pass-through lines, namely, the power line 102, the signal line 104, and the ground line 106.

In an embodiment, the master controller 110-1 includes a master control unit 112 for controlling a first switch 114 and a second switch 116. The master controller 110-1 may further include a first sensor 113 coupled to the master control unit 112. The first switch 114 may transfer the power signal (having a voltage V_{supply}) from the power supply to the modules of the modular lighting system 100-1 via the power line 102, or cut off power to the modules, according to a control signal from the master control unit 112. In an embodiment, the master control unit 112 actuates (e.g., opens/closes) the first switch 114 based on a disable signal received from external circuitry. In an example in which the modular lighting system 100-1 is utilized in a trailer of a truck, a disable signal may be received when the trailer is in motion or when the brakes are engaged while the truck is in motion, thus, cutting off power to the modules of the modular lighting system 100-1. Such a safety feature may be employed in order to prevent the light modules 130-1 (e.g., light modules 130-1a and 130-1b) from draining the tractor/trailer batteries when the truck is in motion, or to increase (e.g., maximize) the power available to the anti-lock brakes of the trailer during a braking action. The second switch 116 may couple (e.g., electrically connect) the signal line 104 to the power line 102, thus providing electrical power to the modules through the signal line 104. The second switch 116 may also decouple (e.g., electrically disconnect) the signal line 104 from the power line 102, thus floating the signal line 104. The master control unit 112 may actuate the second switch 116 based on input received from the first sensor (e.g., a motion sensor, a proximity sensor, a temperature sensor, a sound sensor, etc.) 113 integrated with the master controller 110-1. For example, the master control unit 112 may activate (e.g. close) the second switch 116 when user motion is detected and provide electrical power to the light modules 130-1. Similarly, when no user activity is detected or if a set or predetermined amount of time has passed since the last motion detection event, the master control unit 112 may deactivate (e.g., open) the second switch 116 cutting off power to the light modules 130-1.

According to an embodiment, the dedicated controller 120-1 includes a control unit 122, a second sensor 123, a bypass switch 124, which is actuated by the control unit 122, and an output bypass port 126 at its output for supplying a bypass signal to the input bypass port 136 of the adjacent light module 130-1a. The second sensor 123 may include a motion sensor, a proximity sensor, a temperature sensor, a sound sensor, and/or the like, for detecting an associated trigger event. In an embodiment, when the second sensor 123 detects a trigger event (e.g., a user motion), the control unit 122 activates (e.g. closes) the bypass switch 124 to electrically couple (e.g., electrically connect) the power line 102 to the output bypass port 126 and to provide electrical power to the adjacent light module 130-1a irrespective of the state of the signal line 104, thus bypassing any control input from the master controller 110-1.

In an embodiment, the light module 130-1 (e.g., the paired light module 130-1a/130-1b) includes one or more light-emitting elements 132, such as, one or more light-emitting diodes (LEDs), which are coupled to the signal line 104 through a diode 134 and directly coupled to the input bypass port 136. The input bypass port 136 may receive the bypass signal from an adjacent dedicated controller (e.g., a paired dedicated controller) 120-1, as shown with respect to light module 130-1a, or may be left open (i.e., not electrically connected to any other circuit), as shown with respect to light module 130-1b. In the absence of a paired/adjacent dedicated controller 120-1, the diode 134 allows the light module 130-1 (e.g., the unpaired light module 130-1b) to draw power from the signal line 104 and, thus, be controlled by the master controller 110-1. However, when a paired/adjacent dedicated controller 120-1 is present, the light module 130-1 (e.g., light module 130-1a) may be powered by paired/adjacent dedicated controller 120-1 even when the master controller 110-1 has cut off power to the signal line 104 and calls for the light modules 130 to be turned off.

While not shown in FIG. 2A, according to some embodiments, an electrical line carrying the bypass signal received at the input bypass port 136 of the light module 130-1a extends through the light module 130-1a to an output bypass port to be coupled to an input bypass port 136 of a subsequent light module 130-1b. Thus, in some embodiments, a dedicated controller 120-1 may control an ON/OFF state of two or more of the successive light modules 130-1, which precede a subsequent dedicated controller 120-2.

FIG. 2B is a schematic diagram of the modular lighting system 100-2 showing the internal circuitry of some of the constituent modules, according to another embodiment of the present invention. The modular lighting system 100-2 may be substantially similar to the modular lighting systems 100 and 100-1 described with reference to FIGS. 1 and 2A, except that the modular lighting system 100-2 does not utilize a signal line and only includes two pass-through lines, namely, the power line 102 and the ground line 106.

In an embodiment, the master controller 110-2 includes a master control unit 212 for controlling a switch 214. The master controller 110-1 may further include a first sensor 213 coupled to the master control unit 212. The master control unit 212 may actuate the switch 214 based on a disable signal received from an external circuitry and an input from the first sensor 213 integrated with the master controller 110-2. When the disable signal is present, the master control unit 212 may cut off power to the modules of the modular lighting system 100-2 by deactivating (e.g., opening) the switch 214. The switch 214 may also be deactivated (e.g., opened) when no user activity is detected or if a set or predetermined amount of time has passed since the last motion detection event. The master control unit 212 may activate (e.g., close) the switch 214 when a trigger event is detected, thus providing electrical power to the modules of the modular lighting system 100-2.

According to an embodiment, the dedicated controller 120-2 includes a control unit 222, a power switch 224, which is actuated by the control unit 222 based on an input from a second sensor 223, and an output power port 226 for supplying the power signal to the adjacent light module 130-2a. When the second sensor 223 detects a trigger event (e.g., a user motion), the control unit 222 turns on the power switch 224 to electrically couple (e.g., electrically connect) the power line 102 to the output power port 226.

In an embodiment, the light module 130-2 (e.g., the light module 130-2a/130-2b) includes one or more light-emitting elements 232, such as, light-emitting diodes (LEDs), which are coupled to (e.g., directly coupled to) the input power port 136. The input power port 136 may receive the power signal from an adjacent dedicated controller e.g., a paired dedicated controller) 120-2, as shown with respect to light module 130-2a, or may be electrically shorted to the power line 102 through a conduction path 234, as shown with respect to light module 130-2b.

Thus, when the master control unit 212 detects a trigger event and activates (e.g., closes) the switch 214, electrical power is provided to all of the modules of the modular lighting system 100-2, and all light modules 130-2b that are not paired with a dedicated controller 120-2 will turn on. Paired light modules 130-2a (that are adjacent to and controlled by a dedicated controller 120-2) may turn on when the second sensor 223 also detects a trigger event (which may or may not be the same as the trigger event associated with the master controller 110-2). However, when the master controller 110-2 cuts off power to the power line 102 (e.g., as a result of passage of a set or predetermined time from the trigger event), all light modules 130-2 (e.g., light modules 130-2a and 130-2b) will turn off irrespective of any trigger events detected by any dedicated controller 120-2.

In the embodiments described above, the ground line 106 is a pass-through line; however, embodiments of the present invention are not limited thereto. For example, the modules of the modular lighting systems 100/100-1/100-2 may not share a common pass-through ground line 106, and instead, may be connected to ground via housings, assemblies, or other structures that are shorted to ground. As a result, according to some embodiments, the modular lighting systems 100 and 100-1 may only employ two pass-through lines (e.g., a power line 102 and a signal line 106), while the modular lighting system 100-2 may employ only a single pass-through line (e.g., the power line 102).

While not shown in FIG. 2B, according to some embodiments, an electrical line carrying the bypass signal received at the input bypass port 236 of the light module 130-2a extends through the light module 130-2a to an output bypass port to be coupled to an input bypass port 236 of a subsequent light module 130-2b. Thus, in some embodiments, a dedicated controller 120-2 may control an ON/OFF state of two or more of the successive light modules 130-2, which precede a subsequent dedicated controller 120-2.

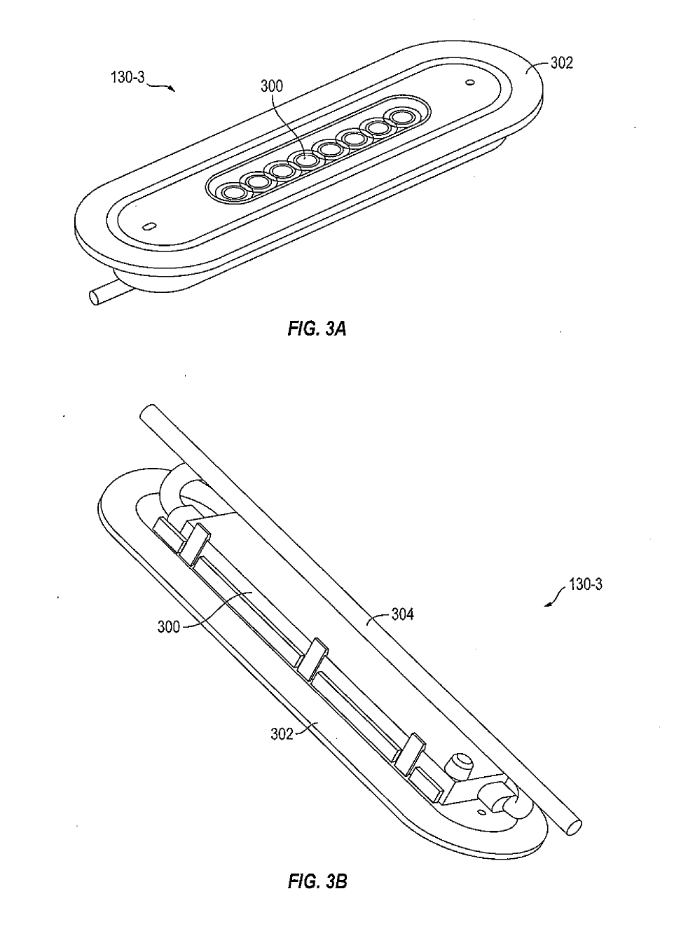

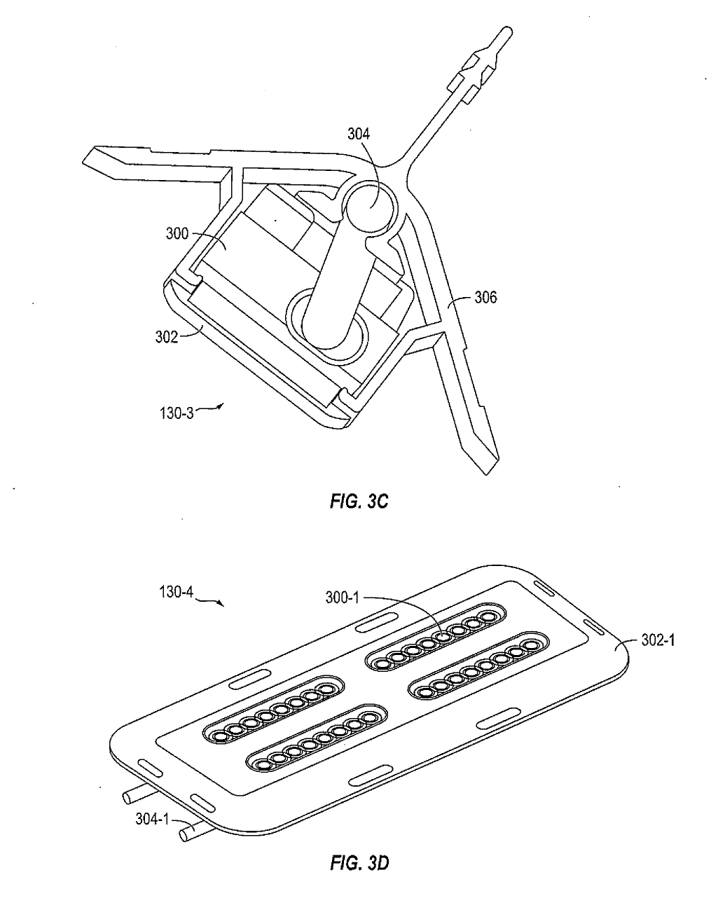

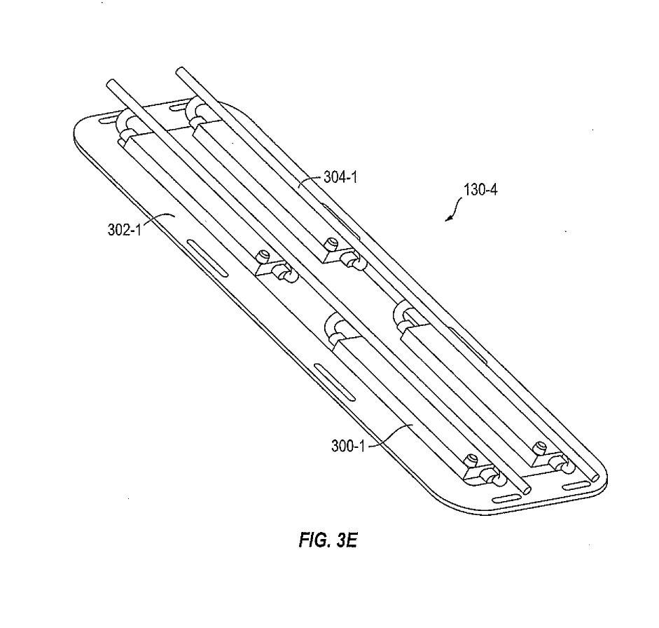

FIGS. 3A-3C illustrate perspective views of a light module 130-3, according to an embodiment of the present invention. The light module 130-3 may include a single lighting unit 300, an exterior housing (e.g., a faceplate) 302 for covering the light module 130-3, and a cylindrical snap 304 for coupling the light module 130-3 to an extrusion 306. The cylindrical snap 304 may carry the pass-through lines (e.g., the power line 102, the signal line 104, and the ground line 106) and may be designed to snap into the extrusion 306. The extrusion 306 may be affixed to a structure such as the interior of a trailer.

FIGS. 3D-3E illustrate perspective views of a light modules 130-4, according to another embodiment of the present invention. The light module 130-4 includes an exterior housing (e.g., a faceplate) 302-1 having two rows, each containing two light units 300-1. The lights units 300-1 in a row may share a common cylindrical snap 304-1.

While this invention has been described in detail with particular references to illustrative embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the inventive concept” Also, the term “exemplary” is intended to refer to an example or illustration.

It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. When an element or layer is referred to as being “directly on,” “directly connected to”, “directly coupled to”, or “immediately adjacent to” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

The master controller and the dedicated controllers (hereinafter “controllers”) and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the controllers may be formed on one integrated circuit (IC) chip or on separate IC chips. Further, the various components of the controllers may be implemented on a flexible printed circuit film, a tape carrier package (TCP), a printed circuit board (PCB), or formed on a same substrate as the controllers. Further, the various components of the controllers may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

What is claimed is:

1. A modular lighting system comprising:
a plurality of light modules;
a master controller comprising a first sensor configured to detect a first trigger event, the master controller being configured to control a state of the plurality of light modules based on the detection of the first trigger event; and
one or more dedicated controllers comprising a first dedicated controller, the first dedicated controller comprising a second sensor configured to detect a second trigger event, the first dedicated controller being configured to control one or more adjacent light modules of the plurality of light modules based on the detection of an associated second trigger event,
wherein the plurality of light modules and the one or more dedicated controllers are coupled to the master controller along a serial connection through one or more pass-through electrical connections.

2. The modular lighting system of claim 1, wherein each of the one or more dedicated controllers is configured to control only a corresponding nearest one of the one or more adjacent light modules.

3. The modular lighting system of claim 1,
wherein each of the one or more dedicated controllers is configured to control only the one or more adjacent light modules, and
wherein the one or more adjacent light modules comprise all of light modules of the plurality of light modules following the first dedicated controller along the serial connection, and preceding a termination module or a subsequent dedicated controller of the one or more dedicated controllers.

4. The modular lighting system of claim 1, wherein the each of the first and second sensors comprises at least one of a motion sensor, a proximity sensor, a temperature sensor, and a sound sensor.

5. The modular lighting system of claim 1, wherein one of the first and second sensors is configured to respond to a trigger event different from an other one of the first and second sensors.

6. The modular lighting system of claim 1, wherein each of the one or more dedicated controllers is configured to control the one or more adjacent light modules by overriding the master controller.

7. The modular lighting system of claim 1, wherein the master controller further comprises a first switch configured to supply power to, and to cut off power from, all of the one or more dedicated controllers and the plurality of light modules in response to a lack of trigger event for a period of time.

8. The modular lighting system of claim 1, wherein the master controller further comprises a first switch configured to supply power to, and to cut off power from, all of the one or more dedicated controllers and the plurality of light modules in response to a disable signal received from external circuitry.

9. The modular lighting system of claim 1, wherein the master controller is configured to control a state of each of the plurality of light modules not adjacent to a preceding dedicated controller of the one or more dedicated controllers.

10. The modular lighting system of claim 1, wherein each of the plurality of light modules is configured to be controlled by the master controller when not adjacent to a preceding dedicated controller of the one or more dedicated controllers.

11. The modular lighting system of claim 1, wherein each of the plurality of light modules is configured to receive power from the master controller and/or an adjacent one of the one or more dedicated controllers.

12. The modular lighting system of claim 1, wherein the one or more pass-through electrical connections comprise a common power supply and a common ground.

13. The modular lighting system of claim 1, further comprising a terminal module configured to isolate output ports of a last light module of the plurality of light modules from the external environment.

14. The modular lighting system of claim 1,
wherein a number of input ports of the one or more dedicated controllers is the same as a number of the one or more pass-through electrical connections, and
wherein a number of output ports of the one or more dedicated controllers is one greater than the number of input ports.

15. The modular lighting system of claim 1,
wherein a number of output ports of the plurality of light modules is the same as a number of the one or more pass-through electrical connections, and
wherein a number of input ports of the plurality of light modules is one greater than the number of output ports.

16. The modular lighting system of claim 1, wherein outputs of the one or more dedicated controllers are configured to mate with and directly engage inputs of the plurality of light modules.

17. The modular lighting system of claim 1, wherein any of the plurality of light modules and the sensors are interchangeable with one another.

18. A modular lighting system comprising:
a plurality of light modules;
a master controller comprising a first sensor configured to detect a first trigger event, the master controller being configured to control a state of the plurality of light modules based on the detection of the first trigger event; and
one or more dedicated controllers comprising a first dedicated controller, the first dedicated controller comprising a second sensor configured to detect a second trigger event, the first dedicated controller being configured to control one or more adjacent light modules of the plurality of light modules based on the detection of an associated second trigger event,
wherein the plurality of light modules and the one or more dedicated controllers are coupled to the master controller in a tree structure comprising one or more branches, ones of the plurality of light modules and ones of the one or more dedicated controllers coupled along a same branch of the one or more branches being configured to receive electrical power and a control signal from a same one or more pass-through electrical connections.
